(19) United States
(12) Patent Application Publication
(10) Pub. No.: US 2014/0159629 A1
(43) Pub. Date: Jun. 12, 2014

(54) MOTOR DRIVING CONTROL APPARATUS AND METHOD, AND MOTOR USING THE SAME

(71) Applicant: SAMSUNG ELECTRO-MECHANICS CO., LTD., Suwon (KR)

(72) Inventor: Joo Yul KO, Gyunggi-do (KR)

(73) Assignee: SAMSUNG ELECTRO-MECHANICS CO., LTD., Suwon (KR)

(21) Appl. No.: 13/770,915

(22) Filed: Feb. 19, 2013

(30) Foreign Application Priority Data
Dec. 11, 2012 (KR) 10-2012-0143469

(51) Int. Cl. H02P 6/00

(52) U.S. Cl. CPC H02P 6/00
USPC 318/400.23

(57) ABSTRACT

There are provided a motor driving control apparatus and method, and a motor using the same, the motor driving apparatus including a driving signal generating unit generating a driving control signal for controlling the driving of a motor apparatus, a speed detecting unit detecting a rotation speed of the motor apparatus, and a frequency determining unit controlling the driving signal generating unit to vary a frequency of the driving control signal according to the rotation speed.

### CROSS-REFERENCE TO RELATED APPLICATIONS

This application claims the priority of Korean Patent Application No. 10-2012-0143469 filed on Dec. 11, 2012, in the Korean Intellectual Property Office, the disclosure of which is incorporated herein by reference.

### BACKGROUND OF THE INVENTION

1. Field of the Invention

The present invention relates to a motor driving control apparatus and method, and a motor using the same.

2. Description of the Related Art

In accordance with the development of motor technology, motors having various sizes have been used in a wide range of fields.

Generally, a motor is driven by rotating a rotor using a permanent magnet and a coil having polarities changed according to current applied thereto. Initially, a brush type of motor in which a rotor is provided with a coil was provided. However, this motor has a problem such as brush abrasion, spark generation, or the like, due to driving of the motor.

Therefore, recently, various types of brushless motors have generally been used. The brushless motor, a direct current (DC) motor driven using an electronic rectifying tool instead of a mechanical contact such as a brush, a commutator, or the like, may include a rotor formed of a permanent magnet and a rotor including coils corresponding to a plurality of phases to thereby be rotated by magnetic force generated by phase voltages of the respective coils.

In order to allow the brushless motor to be efficiently driven, commutation of the respective coils of a stator should be provided at an appropriate point. This commutation may be obtained by switching the respective coils.

In addition, the driving control of a motor apparatus is performed using a driving control signal (for example, a pulse width modulation (PWM) signal). This driving control signal has a constant frequency. However, in the case in which the frequency of the driving control signal is relatively high, stress is applied to a motor driving device (for example, a power field effect transistor (FET)), such that durability of the motor apparatus may be deteriorated.

Therefore, a technology for reducing the frequency of the driving control signal has been disclosed, but this low frequency may cause noise in a surrounding environment.

The following Related Art Documents, which relate to a motor technology as described above, have a limitation in that the above-mentioned problem may not be solved.

### RELATED ART DOCUMENT

Japanese Patent Laid-open Publication No. 2010-104170
Korean Patent Laid-Open Publication No. 2001-0073638

### SUMMARY OF THE INVENTION

An aspect of the present invention provides a motor driving control apparatus and method capable of significantly reducing noise while reducing stress of a motor apparatus by variably changing a frequency of a driving control signal according to a rotation speed of the motor apparatus, and a motor using the same.

According to an aspect of the present invention, there is provided a motor driving control apparatus including: a driving signal generating unit generating a driving control signal for controlling the driving of a motor apparatus; a speed detecting unit detecting a rotation speed of the motor apparatus; and a frequency determining unit controlling the driving signal generating unit to vary a frequency of the driving control signal according to the rotation speed.

The frequency determining unit may include: a comparator comparing the rotation speed detected in the speed detecting unit and a preset reference speed; and a frequency determiner controlling the driving signal generating unit to generate the driving control signal using an audio frequency band when the rotation speed is higher than the reference speed.

The driving signal generating unit may include: a triangle wave generator generating a triangle wave having a predetermined frequency; and a comparator synthesizing an input signal and the triangle wave to generate the driving control signal.

The triangle wave generator may variably change the frequency of the triangle wave according to a control of the frequency determining unit.

When the triangle wave generator receives a frequency setting signal from the frequency determining unit, the triangle wave generator may generate the triangle wave using a frequency matching an audio frequency or less.

The driving signal generating unit may include: a triangle wave generator generating a triangle wave having a preset frequency; a comparator synthesizing an input signal and the triangle wave to generate a synthesis signal; and a frequency modulator modulating a frequency of the synthesis signal to generate the driving control signal.

The speed detecting unit may detect back-electromotive force generated by the motor apparatus to detect the rotation speed.

The motor driving control apparatus may further include a controlling unit confirming a phase inversion point of the motor apparatus using back-electromotive force and controlling the driving signal generating unit to drive the motor apparatus by using the confirmed phase inversion point.

According to another aspect of the present invention, there is provided a motor including: a motor apparatus performing a rotation operation according to a driving control signal; and a motor driving control apparatus providing the driving control signal to the motor apparatus to control the driving of the motor apparatus and varying a frequency of the driving control signal according to a rotation speed of the motor apparatus.

The motor driving control apparatus may include: a driving signal generating unit generating a driving control signal for controlling the driving of a motor apparatus; a speed detecting unit detecting a rotation speed of the motor apparatus; and a frequency determining unit controlling the driving signal generating unit to vary a frequency of the driving control signal according to the rotation speed.

The frequency determining unit may include: a comparator comparing the rotation speed detected in the speed detecting unit and a preset reference speed; and a frequency determiner controlling the driving signal generating unit to generate the driving control signal using a frequency matching an audio frequency or less when the rotation speed is higher than the reference speed.

The driving signal generating unit may include: a triangle wave generator generating a triangle wave having a predetermined frequency; and a comparator synthesizing an input signal and the triangle wave to generate the driving control signal.

When the triangle wave generator receives a frequency setting signal from the frequency determiner, the triangle wave generator may generate the triangle wave using the frequency matching the audio frequency or less.

The driving signal generating unit may include: a triangle wave generator generating a triangle wave having a preset frequency; a comparator synthesizing an input signal and the triangle wave to generate a synthesis signal; and a frequency modulator modulating a frequency of the synthesis signal to generate the driving control signal.

According to another aspect of the present invention, there is provided a motor driving control method performed in a motor driving control apparatus controlling the driving of a motor apparatus, the motor driving control method including: applying a driving control signal to the motor apparatus to drive the motor apparatus; detecting a rotation speed of the motor apparatus to compare the detected rotation speed and a reference speed; and modulating a frequency of the driving control signal when the rotation speed is higher than the reference speed.

The modulating of the frequency of the driving control signal may include generating the driving control signal using a frequency matching an audio frequency or less when the rotation speed is higher than the reference speed.

The modulating of the frequency of the driving control signal may include: generating a triangle wave using the frequency of the audio frequency or less; and synthesizing the triangle wave and an input signal to generate the driving control signal.

The modulating of the frequency of the driving control signal may include: generating a triangle wave having a preset frequency; synthesizing the triangle wave and an input signal to generate a synthesis signal; and modulating the synthesis signal into a signal having a frequency of the audio frequency or less to generate the driving control signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram for describing an example of a motor driving control apparatus according to an embodiment of the present invention;

FIG. 2 is a detailed configuration diagram for describing an example of a frequency determining unit of FIG. 1;

FIG. 3 is a detailed configuration diagram for describing an example of a driving signal generating unit of FIG. 1;

FIG. 4 is a detailed configuration diagram for describing another example of the driving signal generating unit of FIG. 1;

FIGS. 5 and 6 are reference graphs for describing a driving control signal of which a frequency is changed according to an embodiment of the present invention; and

FIG. 7 is a flow chart for describing an example of a motor driving control method according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

Hereinafter, for convenience of explanation, the present invention will be described based on a brushless motor. However, since this is for convenience of explanation, it is obvious that the scope of the present invention is not necessarily limited thereto.

In addition, hereinafter, a motor itself will be known as a motor apparatus 20 or 200, and an apparatus including a motor driving control apparatus 10 or 100 for driving the motor apparatus 20 or 200 and the motor apparatus 20 or 200 will be known as a motor.

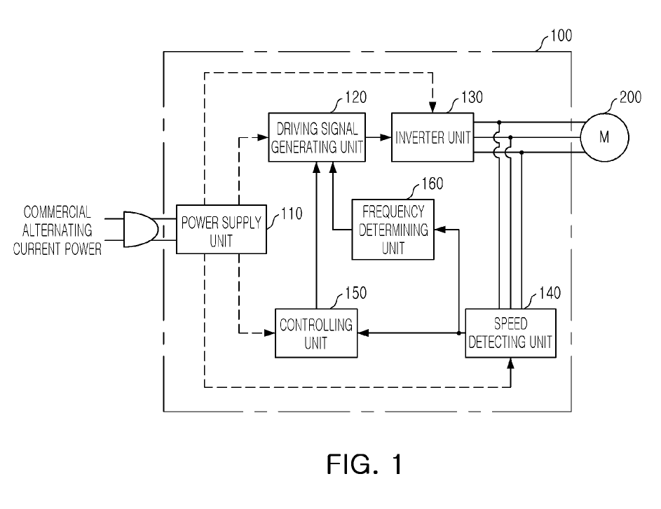

FIG. 1 is a configuration diagram for describing an example of a motor driving control apparatus according to an embodiment of the present invention.

The motor apparatus 200 may perform a rotation operation according to the driving control signal. For example, a magnetic field may be generated in each coil of the motor apparatus 200 by driving current provided from an inverter unit 130. A rotor included in the motor apparatus 200 may be rotated by the magnetic fields generated in the coils as described above.

The motor driving control apparatus 100 may provide a driving control signal to the motor apparatus 200 to control the driving of the motor apparatus 200.

The motor driving control apparatus 100 may vary a frequency of the driving control signal according to a rotation speed of the motor apparatus 200. In the embodiment of the present invention, the motor driving control apparatus 100 may generate the driving control signal using the frequency matching the audio frequency or less when the rotation speed of the motor apparatus 100 is a speed equal to or higher than a preset speed (hereinafter, a reference speed). The reason is that since the audio frequency is a relative low frequency band, when the motor driving control apparatus 100 generates the driving control signal using the frequency of the audio frequency or less, stress by the switching operation may be reduced. Here, the reason of using the reference speed is as follows. When rotation of the motor apparatus 200 reaches a predetermined level or more, noise may be generated by the rotation thereof. In this case, although the motor driving control apparatus 100 generates the driving control signal using the frequency of the audio frequency or less in this case, noise by the driving control signal may not be recognized.

Referring to FIG. 1, the motor driving control apparatus 100 may include a power supply unit 110, a driving signal generating unit 120, an inverter unit 130, a speed detecting unit 140, a controlling unit 150, and a frequency determining unit 160.

The power supply unit 110 may supply power to the respective components of the motor driving control apparatus 100. For example, the power supply unit 110 may convert a commercial alternating current (AC) voltage into a direct current (DC) voltage and supply the DC voltage to the respective components. In the example shown in FIG. 1, a dotted line indicates that predetermined power is supplied from the power supply unit 110.

The driving signal generating unit 120 may provide a driving control signal to the inverter unit 130.

The driving signal generating unit 120 may variably change a frequency according to a control of the frequency determining unit 160 to generate a driving control signal of the motor apparatus 200.

In the embodiment of the present invention, the driving control signal may be a pulse width modulation (PWM) signal. In this case, the driving signal generating unit 120 may apply a variable DC level to a predetermined reference waveform (for example, a triangle wave) to adjust a duty ratio of the pulse width modulation signal.

The driving signal generating unit 120 will be described in more detail below with reference to FIGS. 3 and 4.

The inverter unit 130 may operate the motor apparatus 200. For example, the inverter unit 130 may convert a direct current (DC) voltage into a plural-phase (for example, a three-phase or a four-phase) voltage according to the driving control signal and apply the plural-phase voltage to the respective coils (corresponding to the plural phase) of the motor apparatus 200, thereby operating the rotor of the motor apparatus 200.

The speed detecting unit 140 may detect the rotation speed of the motor apparatus 200.

In the embodiment of the present invention, the speed detecting unit 140 may detect back-electromotive force of the motor apparatus 200. More specifically, in the case in which the motor apparatus 200 rotates, back-electromotive force may be generated in the coil provided in the rotor. That is, back-electromotive force is generated in the coils to which the phase voltage is not applied among a plurality of coils, and the speed detecting unit 140 may detect back-electromotive force generated in the respective coils of the motor apparatus 200. The speed detecting unit 140 may calculate the rotation speed of the motor apparatus 200 using the detected back-electromotive force. Alternatively, the speed detecting unit 140 may provide the detected back-electromotive force to the controlling unit 150 to allow the detected back-electromotive force to be used to determine a phase inversion point of the motor apparatus 200.

The controlling unit 150 may confirm a phase inversion point of the motor apparatus 200 using back-electromotive force and control the driving signal generating unit 120 to generate the driving control signal using the confirmed phase inversion point.

In the embodiment in which back-electromotive force is used, the controlling unit 150 may control the driving signal generating unit 120 to perform phase inversion at a zero-crossing point of back-electromotive force.

The frequency determining unit 160 may control the driving signal generating unit 120 to vary the frequency of the driving control signal according to the rotation speed of the motor apparatus 200.

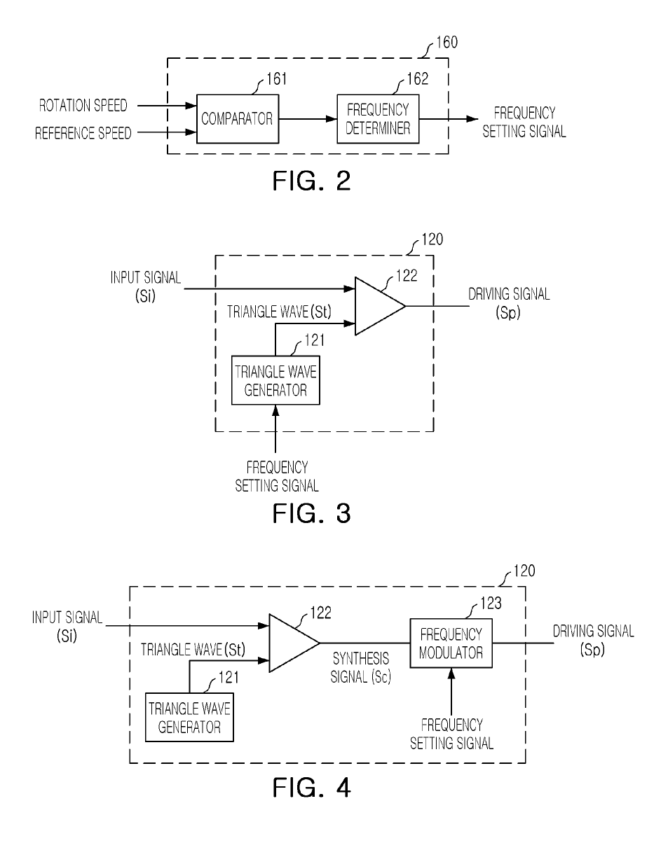

This frequency determining unit 160 will be described in more detail below with reference to FIG. 2.

FIG. 2 is a detailed configuration diagram for describing an example of the frequency determining unit of FIG. 1.

Referring to FIG. 2, the frequency determining unit 160 may include a comparator 161 and a frequency determiner 162.

The comparator 161 may compare the rotation speed detected in the speed detecting unit 140 and the preset reference speed. For example, the comparator 161 may output “High” when the rotation speed is higher than the reference speed.

The frequency determiner 162 may determine a frequency band of the driving control signal. Hereinafter, a signal output from the frequency determiner 162 to be inputted to the driving signal generating unit 120 in order to control the frequency of the driving control signal will be referred to as a frequency setting signal.

In the embodiment of the present invention, the frequency determiner 162 may control the driving signal generating unit 120 to generate the driving control signal using an audio frequency band when the rotation speed is higher than the reference speed.

In the embodiment of the present invention, the driving signal generating unit 120 may generate the driving control signal using two frequency bands (a general frequency band, a frequency band of an the audio frequency or less), and when the driving signal generating unit 120 receives the frequency setting signal from the frequency determiner 162, the driving signal generating unit 120 may generate the driving control signal using the frequency band of the audio frequency or less. Here, the general frequency band, a frequency of the general driving control signal used in the motor apparatus 200, is a frequency band higher than the audio frequency.

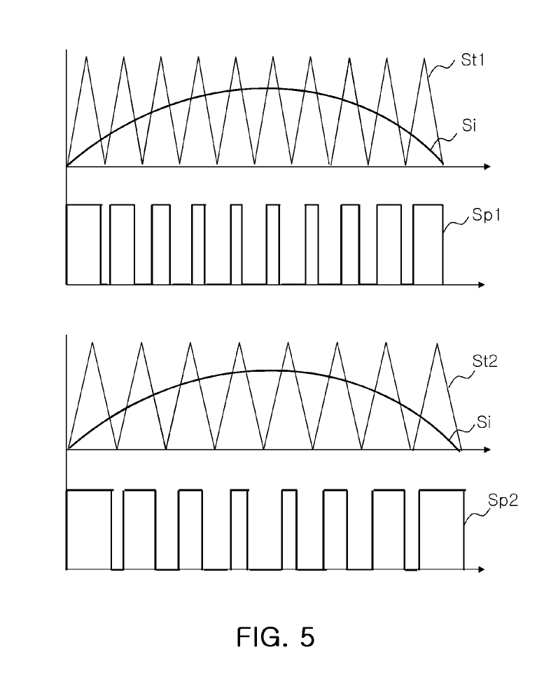

FIG. 3 is a detailed configuration diagram for describing an example of the driving signal generating unit of FIG. 1, and FIG. 5 is reference graphs for describing a driving control signal generated by the driving signal generating unit of FIG. 3.

The embodiment shown in FIG. 3 provides an example in which the frequency of the driving control signal is varied by varying a frequency of a triangle wave.

Referring to FIG. 3, the driving signal generating unit 120 may include a triangle wave generator 121 and a comparator 122.

The triangle wave generator 121 may generate a triangle wave having a predetermined frequency. Here, the triangle wave may include a saw-tooth wave, a triangle wave, a triangle-sine wave, or the like.

In the embodiment of the present invention, the triangle wave generator 121 may variably change the frequency of the triangle wave according to the control of the frequency determining unit 160.

For example, the triangle wave generator 121 may generate a triangle wave St using a frequency of the audio frequency or less when the triangle wave generator 121 receives the frequency setting signal from the frequency determiner 162.

The comparator 122 may synthesize an input signal Si and the triangle wave St to generate a driving control signal Sp.

With reference to the example shown in FIG. 5, an upper graph shows an example of generating the driving control signal (here, a PWM signal) using a frequency in a general band since the rotation speed of the motor apparatus 200 is less than the reference speed, and a lower graph shows an example of generating the driving control signal using a frequency of the audio frequency or less since the rotation speed is higher than the reference speed.

As shown in FIG. 5, it may be appreciated that when the triangle wave St1 is generated using the frequency in the general band, the driving control signal Sp1 obtained by synthesizing the triangle wave St1 and the input signal Si also has a relatively high frequency.

On the other hand, it may be appreciated that when the triangle wave St2 is generated using a frequency of the audio frequency or less, the driving control signal Sp2 obtained by synthesizing the triangle wave St2 and the input signal Si also has a frequency of the audio frequency or less. Therefore, in this case, since a switching speed of the motor apparatus 200 is reduced, stress by the switching may be reduced.

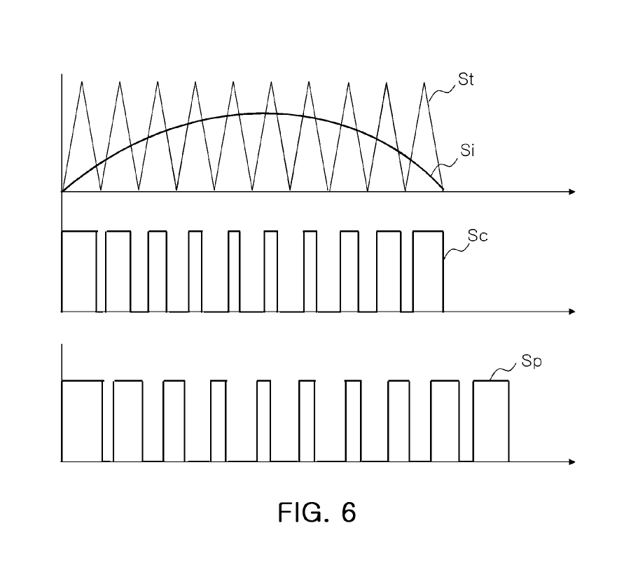

FIG. 4 is a detailed configuration diagram for describing another example of the driving signal generating unit of FIG. 1, and FIG. 6 is a reference graph for describing a driving control signal generated by the driving signal generating unit of FIG. 4.

Another embodiment shown in FIG. 4 provides an example in which the frequency of the generated driving control signal is varied without varying the frequency of the triangle wave St. In a description of another embodiment shown in FIG. 4, overlapped descriptions of contents the same as or corresponding to contents described above with reference to FIG. 3 will be omitted.

Referring to FIG. 4, the driving signal generating unit 120 may include a triangle wave generator 121, a comparator 122, and a frequency modulator 123.

The triangle wave generator 121 may generate a triangular wave St having a predetermined frequency. Here, the predetermined frequency may be a preset fixed frequency.

The comparator 122 may synthesize the input signal Si and the triangle wave St to generate a synthesis signal Sc.

The frequency modulator 123 may modulate a frequency of the synthesis signal Sc to generate a driving control signal.

In the embodiment of the present invention, the frequency modulator 123 may modulate the frequency of the synthesis signal Sc according to the control of the frequency determining unit 160 to generate the driving control signal Sp.

For example, when the frequency modulator 123 receives the frequency setting signal from the frequency determiner 162, the frequency modulator 123 may modulate the frequency of the synthesis signal Sc into the frequency matching the audio frequency or less to generate the driving control signal Sp.

With reference to the example shown in FIG. 6, it may be appreciated that when the triangle wave St generated by the triangle wave generator 121 and the input signal Si are synthesized, the synthesis signal Sc may be generated as shown FIG. 6.

In the example shown in FIG. 6, it may be appreciated that when the rotation speed of the motor apparatus 200 is higher than the reference speed, the synthesis signal Sc is modulated to have a relatively lower frequency, such that the driving control signal Sp is generated. Although not shown, in the case in which the rotation speed of the motor apparatus 200 is less than the reference speed, the synthesis signal Sc may be used as a driving control signal.

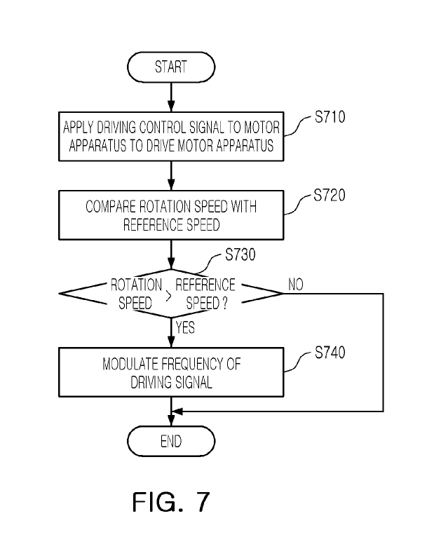

FIG. 7 is a flow chart for describing an example of a motor driving control method according to the embodiment of the present invention.

Hereinafter, an example of a motor driving control method according to the embodiment of the present invention will be described with reference to FIG. 7. Since the example of the motor driving control method according to the embodiment of the present invention is performed in the motor driving control apparatus 100 described above with reference to FIGS. 1 through 6, an overlapped description for contents that are the same as or correspond to the above-mentioned contents will be omitted.

Referring to FIG. 7, the motor driving control apparatus 100 may apply a driving control signal to a motor apparatus 200 to drive the motor apparatus (S710). This operation may include an initial driving in order to calculate a current speed of the motor apparatus 200.

The motor driving control apparatus 100 may detect a rotation speed of the motor apparatus 200 to compare the detected rotation speed with a reference speed (S720). When the rotation speed is higher than the reference speed (S730: yes), a frequency of the driving control signal may be modulated (S740).

In an example of 5740, the motor driving control apparatus 100 may generate the driving control signal using a frequency matching an audio frequency or less when the rotation speed is higher than the reference speed.

For example, the motor driving control apparatus 100 may generate a triangle wave using the frequency of the audio frequency or less and synthesize the triangle wave and an input signal to generate a driving control signal.

In another example, the motor driving control apparatus 100 may generate a triangle wave having a preset frequency and synthesize the triangle wave and an input signal to generate a synthesis signal. The motor driving control apparatus 100 may modulate the synthesis signal into a signal having a frequency of the audio frequency or less, thereby generating the driving control signal.

As set forth above, according to the embodiment of the present invention, the frequency of the driving control signal is variably used according to the rotation speed of the motor apparatus, such that the stress exerted on the motor apparatus may be reduced, and noise may also be significantly reduced.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a driving signal generating unit generating a driving control signal for controlling the driving of a motor apparatus;
a speed detecting unit detecting a rotation speed of the motor apparatus; and
a frequency determining unit controlling the driving signal generating unit to vary a frequency of the driving control signal according to the rotation speed.

2. The motor driving control apparatus of claim 1, wherein the frequency determining unit includes:
a comparator comparing the rotation speed detected in the speed detecting unit and a preset reference speed; and
a frequency determiner controlling the driving signal generating unit to generate the driving control signal using an audio frequency band when the rotation speed is higher than the reference speed.

3. The motor driving control apparatus of claim 1, wherein the driving signal generating unit includes:
a triangle wave generator generating a triangle wave having a predetermined frequency; and
a comparator synthesizing an input signal and the triangle wave to generate the driving control signal.

4. The motor driving control apparatus of claim 3, wherein the triangle wave generator variably changes the frequency of the triangle wave according to a control of the frequency determining unit.

5. The motor driving control apparatus of claim 3, wherein when the triangle wave generator receives a frequency setting signal from the frequency determining unit, the triangle wave generator generates the triangle wave using a frequency matching an audio frequency or less.

6. The motor driving control apparatus of claim 1, wherein the driving signal generating unit includes:
a triangle wave generator generating a triangle wave having a preset frequency;
a comparator synthesizing an input signal and the triangle wave to generate a synthesis signal; and
a frequency modulator modulating a frequency of the synthesis signal to generate the driving control signal.

7. The motor driving control apparatus of claim 1, wherein the speed detecting unit detects back-electromotive force generated by the motor apparatus to detect the rotation speed.

8. The motor driving control apparatus of claim 7, further comprising a controlling unit confirming a phase inversion point of the motor apparatus using back-electromotive force and controlling the driving signal generating unit to drive the motor apparatus by using the confirmed phase inversion point.

9. A motor comprising:
a motor apparatus performing a rotation operation according to a driving control signal; and
a motor driving control apparatus providing the driving control signal to the motor apparatus to control the driving of the motor apparatus and varying a frequency of the driving control signal according to a rotation speed of the motor apparatus.

10. The motor of claim 9, wherein the motor driving control apparatus includes:
a driving signal generating unit generating a driving control signal for controlling the driving of a motor apparatus;
a speed detecting unit detecting a rotation speed of the motor apparatus; and
a frequency determining unit controlling the driving signal generating unit to vary a frequency of the driving control signal according to the rotation speed.

11. The motor of claim 10, wherein the frequency determining unit includes:
a comparator comparing the rotation speed detected in the speed detecting unit and a preset reference speed; and
a frequency determiner controlling the driving signal generating unit to generate the driving control signal using the frequency matching the audio frequency or less when the rotation speed is higher than the reference speed.

12. The motor of claim 10, wherein the driving signal generating unit includes:
a triangle wave generator generating a triangle wave having a predetermined frequency; and
a comparator synthesizing an input signal and the triangle wave to generate the driving control signal.

13. The motor of claim 12, wherein when the triangle wave generator receives a frequency setting signal from the frequency determiner, the triangle wave generator generates the triangle wave using the frequency matching the audio frequency or less.

14. The motor of claim 10, wherein the driving signal generating unit includes:
a triangle wave generator generating a triangle wave having a preset frequency;
a comparator synthesizing an input signal and the triangle wave to generate a synthesis signal; and
a frequency modulator modulating a frequency of the synthesis signal to generate the driving control signal.

15. A motor driving control method performed in a motor driving control apparatus controlling the driving of a motor apparatus, the motor driving control method comprising:
applying a driving control signal to the motor apparatus to drive the motor apparatus;
detecting a rotation speed of the motor apparatus to compare the detected rotation speed and a reference speed; and
modulating a frequency of the driving control signal when the rotation speed is higher than the reference speed.

16. The motor driving control method of claim 15, wherein the modulating of the frequency of the driving control signal includes generating the driving control signal using a frequency matching an audio frequency or less when the rotation speed is higher than the reference speed.

17. The motor driving control method of claim 16, wherein the modulating of the frequency of the driving control signal includes:
generating a triangle wave using the frequency of the audio frequency or less; and
synthesizing the triangle wave and an input signal to generate the driving control signal.

18. The motor driving control method of claim 16, wherein the modulating of the frequency of the driving control signal includes:
generating a triangle wave having a preset frequency;
synthesizing the triangle wave and an input signal to generate a synthesis signal; and
modulating the synthesis signal into a signal having the frequency of the audio frequency or less to generate the driving control signal.
